(19) United States
(12) Patent Application Publication
(10) Pub. No.: US 2025/0102696 A1
(43) Pub. Date: Mar. 27, 2025

(54) HOLOGRAPHIC ELECTROMAGNETIC EXPLORATION METHOD BASED ON FULL-AREA OBSERVATION ALTERNATING COVERAGE INTEGRAL-DIFFERENCE MIXED STIMULUS

(71) Applicant: Central South University, Changsha (CN)

(72) Inventor: Shikun DAI, Changsha (CN)

(73) Assignee: Central South University, Changsha (CN)

(21) Appl. No.: 18/371,883

(22) Filed: Sep. 22, 2023

(51) Int. Cl. G01V 3/08; G03H 1/08

(52) U.S. Cl. CPC G01V 3/081; G03H 1/08

(57) ABSTRACT

The present disclosure provides a holographic electromagnetic exploration method based on full-area observation alternating coverage integral-difference mixed stimulus, including: S1: determining an area to be explored and a core target area of the area to be explored; S2: dividing the area to be explored into a plurality of basic array areas, dividing the core target area into a plurality of staggered array areas, and determining a plurality of mixed stimulus system arrangement positions within the area to be explored; S3: arranging a basic observation array composed of receiving stations in each basic array area successively; and S4: arranging a staggered observation array composed of receiving stations in each staggered array area successively.

### TECHNICAL FIELD

The present disclosure relates to the technical field of geophysical exploration, particularly a holographic electromagnetic exploration method based on full-area observation alternating coverage integral-difference mixed stimulus.

### BACKGROUND

At present, common electromagnetic exploration methods mainly include a direct current (DC) resistivity method, an induced polarization (IP) method (including a time domain induced polarization method, a frequency domain induced polarization method, and a frequency spectrum induced polarization method), a transient electromagnetic (TEM) method, a magnetotelluric (MT) method, a controlled-source electromagnetic (CSEM) method, and the like. Respective instruments and data processing and interpreting systems are provided for different exploration methods. These exploration methods mainly have the following problems.

First, a traditional electromagnetic exploration method uses a single stimulation field source stimulus. With a single emission source polarization mode and a single receiving mode, underground three-dimensional target body information cannot be emitted and received in different modes from different angles and different orientations.

Second, the traditional CSEM method is operable only in a far area and is low in data signal-to-noise ratio; and this method has a field source effect and a shadow effect, is incapable of correctly imaging a complex geological body, and is low in resolution.

Third, the traditional methods can only acquire information of a particular electrical property by a measurement. For a same work area, electrical property information of an underground three-dimensional body can be acquired comprehensively only by repeatedly carrying out field measurement and data processing and interpretation for a plurality of times. Accordingly, the exploration efficiency can be affected to a large extent and unwanted exploration cost is increased.

### SUMMARY

The present disclosure provides a holographic electromagnetic exploration method based on full-area observation alternating coverage integral-difference mixed stimulus to solve the problems of low electromagnetic exploration efficiency and poor exploration effect.

To achieve the above objective, the present disclosure adopts the following technical solutions.

A holographic electromagnetic exploration method based on full-area observation alternating coverage integral-difference mixed stimulus includes:
S1: determining an area to be explored and a core target area of the area to be explored;
S2: dividing the area to be explored into a plurality of basic array areas, dividing the core target area into a plurality of staggered array areas, and determining a plurality of mixed stimulus system arrangement positions within the area to be explored;
S3: arranging a basic observation array composed of receiving stations in each basic array area successively, and adjusting each mixed stimulus system one by one such that the mixed stimulus system stimulates a plurality of polarization modalities including a single field source, a differential field source, and an integral field source successively, during which each receiving station acquires data; and
S4: arranging a staggered observation array composed of receiving stations in each staggered array area successively, and adjusting each mixed stimulus system one by one such that the mixed stimulus system stimulates a plurality of polarization modalities including a single field source, a differential field source, and an integral field source successively, during which each receiving station acquires data.

Further, an electrode system of the mixed stimulus system includes five electrodes arranged centrosymmetrically in a cross form, involving 16 power supply combination modes, where 8 power supply modes of a single set of positive and negative electrodes are configured to stimulate the polarization modality of the single field source; 4 power supply modes of two sets of positive and negative electrodes having a same current flow direction are configured to stimulate the polarization modality of the integral field source; and 4 power supply modes of two sets of positive and negative electrodes having opposite current flow directions are configured to stimulate the polarization modality of the differential field source.

Further, the staggered observation array and the basic observation array follow an arrangement principle of the mixed stimulus system being shared and the receiving stations being densified.

Further, the adjusting each mixed stimulus system one by one such that the mixed stimulus system stimulates a plurality of polarization modalities including a single field source, a differential field source, and an integral field source successively, during which each receiving station acquires data, specifically includes the following steps:
A1: turning on a mixed stimulus system to stimulate the plurality of polarization modalities including the single field source, the differential field source, and the integral field source successively, and acquiring data by each receiving station, and at this time, enabling an idle charging mode for other mixed stimulus systems; and
A2: turning on other mixed stimulus systems in sequence to perform observation according to step A1.

Further, the data acquired by each receiving station includes two electric field components and/or three magnetic field components.

Further, an emission signal of the mixed stimulus system is a square wave signal of 1000 Hz to a low frequency of 0.1 Hz.

Further, during emission of the mixed stimulus system, each receiving station acquires an artificial source electric field and/or magnetic field signal; and

in an emission interval of the mixed stimulus system, each receiving station acquires a natural source electric field and/or magnetic field signal.

Further, the holographic electromagnetic exploration method based on full-area observation alternating coverage integral-difference mixed stimulus further includes:
separating all the acquired data into two parts: artificial source signals and natural source signals;
identifying and extracting a time domain signal and a frequency domain signal from the artificial source signals and natural source signals, respectively, to obtain resistivity information and polarizability information of an underground medium; and
performing holographic synthesized inversion imaging on all the acquired data.

### Beneficial Effects

The present disclosure provides a holographic electromagnetic exploration method based on full-area observation alternating coverage integral-difference mixed stimulus, which has the following advantages:

(1) Three stimulus modes of a single field source, a differential field source, and an integral field source can be realized physically, and underground three-dimensional target body information can be acquired in different modes from different angles and different orientations. Correct imaging is facilitated and the resolution is increased.

(2) Breaking through the boundary of far area observation, the influences of the field source effect and the shadow effect can be avoided, and a correct exploration effect can be achieved under complex conditions.

(3) Information on “geometric sounding (a change in separation between a receiver and a transmitter)” and “electromagnetic induction (a frequency change)”, information on the single field source, the differential field source, and the integral field source, time domain, and frequency domain information, information of an artificial field source and a natural field source, resistivity and polarizability information, and information of electromagnetic field components and gradients thereof are acquired synchronously by performing field acquisition once, and the exploration efficiency is high.

(4) The holographic electromagnetic exploration method based on full-area observation alternating coverage integral-difference mixed stimulus can be applied to exploration of oil gas, mineral resources, engineering and environment, terrestrial heat, underground water, and the like, and is also applicable to electromagnetic exploration in different fields of land, aviation, sea, and the like.

### BRIEF DESCRIPTION OF THE DRAWINGS

To describe the technical solutions in embodiments of the present disclosure or in the prior art more clearly, the accompanying drawings needed in describing the embodiments or the prior art will be briefly described below. Apparently, the accompanying drawings in the following description show merely some embodiments of the present disclosure, and other drawings can be derived from the accompanying drawings by those of ordinary skill in the art without creative efforts.

FIG. 1 is a flowchart of a holographic electromagnetic exploration method based on full-area observation alternating coverage integral-difference mixed stimulus provided by an embodiment of the present disclosure;

FIG. 2 is a schematic diagram of divisions of an area to be explored and a core target area provided by an embodiment of the present disclosure;

FIG. 3 is a schematic diagram of an arrangement of mixed stimulus systems and observation arrays provided by an embodiment of the present disclosure;

FIGS. 4A-G illustrate densified arrangement manners of staggered observation arrays provided by an embodiment of the present disclosure, where FIG. 4A is a one-point densification manner; (FIG. 4B) and (FIG. 4C) are two two-point densification manners; (FIG. 4D) and (FIG. 4E) are two three-point densification manners; and (FIG. 4F) and (FIG. 4G) are two four-point densification manners;

FIG. 5 is a schematic diagram of an electrode arrangement manner of a mixed stimulus system provided by an embodiment of the present disclosure;

FIGS. 6A-H are schematic diagrams of 8 power supply modes corresponding to a single field source polarization modality, where FIG. 6A to FIG. 6H correspond to 8 power supply modes;

FIGS. 7A-D are schematic diagrams of 4 power supply modes corresponding to an integral field source polarization modality, where FIG. 7A to FIG. 7D correspond to 4 power supply modes; and

FIGS. 8A-D are schematic diagrams of 4 power supply modes corresponding to a differential field source polarization modality, where FIG. 8A to FIG. 8 correspond to 4 power supply modes.

### DETAILED DESCRIPTION OF THE EMBODIMENTS

To make the objectives, technical solutions, and advantages of the present disclosure more clearly, the technical solutions of the present disclosure will be described in detail below. Apparently, the described embodiments are only a part rather than all of the embodiments of the present disclosure. All other embodiments derived from the embodiments in the present disclosure by a person of ordinary skill in the art without creative efforts shall fall within the protection scope of the present disclosure.

In view of the problems existing in the existing geophysical exploration methods, an embodiment of the present disclosure provides a holographic electromagnetic exploration method based on integral-difference mixed stimulus that can omnidirectionally stimulate an underground target body, receive electromagnetic field information, perform inversion imaging with all information, and realize electromagnetic holographic exploration. The major content of the holographic electromagnetic exploration method based on mixed stimulus provided by the embodiment is described specifically below.

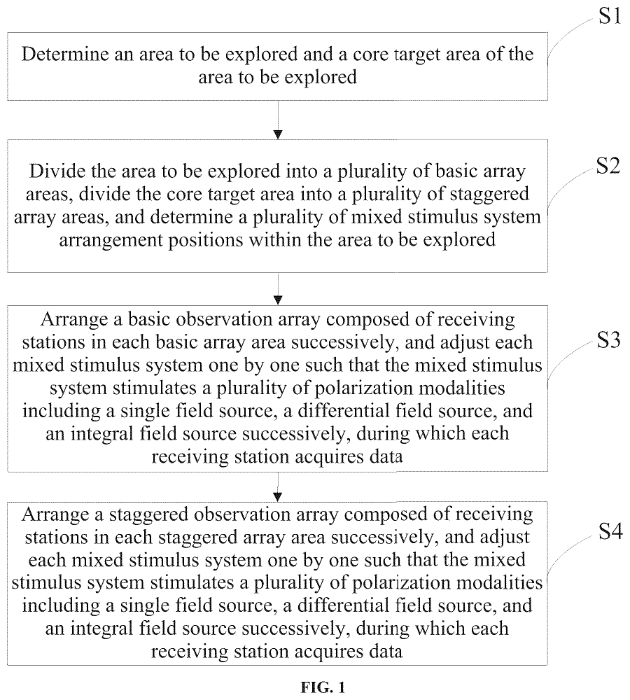

As shown in FIG. 1, the embodiment of the present disclosure provides a holographic electromagnetic exploration method based on full-area observation alternating coverage integral-difference mixed stimulus, including the following steps.

S1: an area to be explored and a core target area of the area to be explored are determined according to an exploration requirement.

S2: the area to be explored is divided into a plurality of basic array areas and the core target area is divided into a plurality of staggered array areas; and a plurality of mixed stimulus system arrangement positions are determined within the area to be explored.

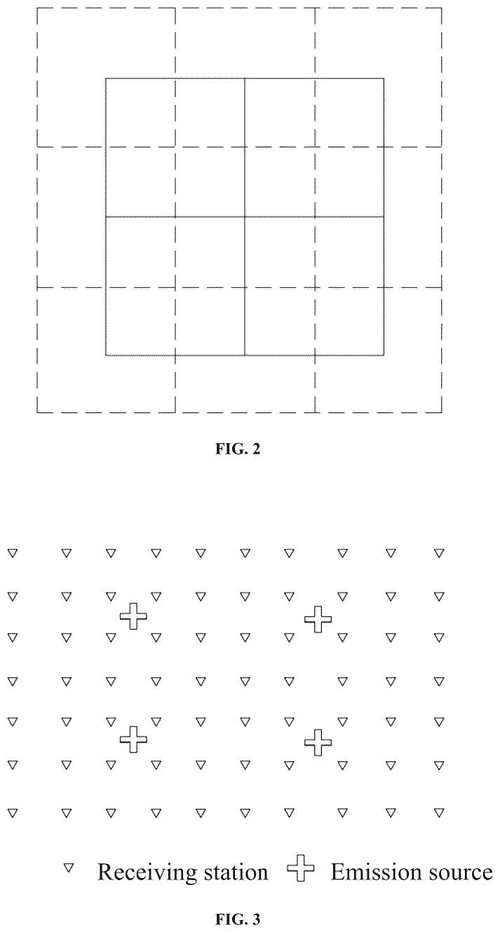

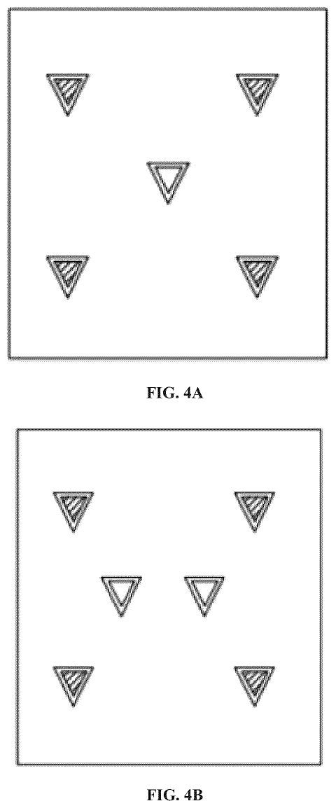

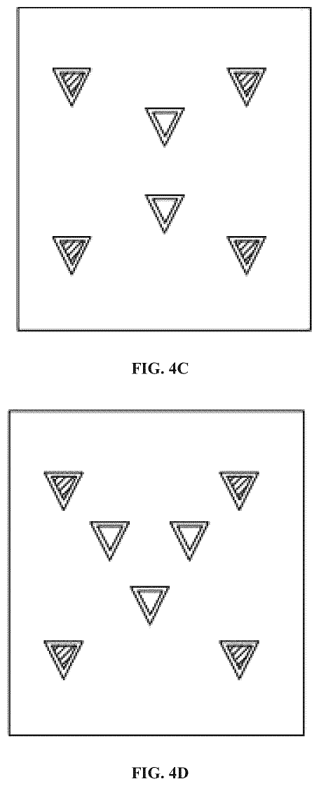

According to the size of an actual basic observation array, the area to be explored is divided in units of the basic observation array. Meanwhile, for the core target area, according to a size of an actual staggered observation array, the core target area is divided in units of the staggered observation array. As shown in FIG. 2, the dashed boxes represent the plurality of basic array areas divided from the area to be explored, and the solid boxes represent the plurality of staggered array areas divided from the core target area. A number and arrangement positions of the mixed stimulus systems are determined according to a size of the area to be explored, and a distance between mixed stimulus systems, a number of receiving stations and a distance between receiving stations in an observation array may be adjusted appropriately according to a requirement on an elaborate degree of exploration. As in FIG. 3, a schematic diagram of an arrangement of mixed stimulus systems and observation arrays is shown.

S3: a basic observation array composed of receiving stations is arranged in each basic array area successively, and each mixed stimulus system is adjusted one by one to stimulate a plurality of polarization modalities including a single field source, a differential field source, and an integral field source successively, during which each receiving station acquires data. Specific steps are as follows:

S31: a basic array area is selected and basic observation arrays are arranged within the basic array area.

S32: a mixed stimulus system is firstly turned on to stimulate the plurality of polarization modalities including the single field source, the differential field source, and the integral field source successively; each receiving station acquires data; and at this time, an idle charging mode is enabled for other mixed stimulus systems.

S33: other mixed stimulus systems are turned on in sequence to perform observation according to step S32.

S34: next basic array area is selected and steps S31 to S34 are repeated until the observation is completed for all the basic array regions. Thus, full-area basic array observation in the area to be explored is realized.

S4: arranging a staggered observation array composed of receiving stations in each staggered array area successively, and adjusting each mixed stimulus system one by one such that the mixed stimulus system stimulates a plurality of polarization modalities including a single field source, a differential field source, and an integral field source successively, during which each receiving station acquires data. Specific steps are as follows:

S41: a staggered array area is selected and staggered observation arrays are arranged within the staggered array area.

S42: a mixed stimulus system is firstly turned on to stimulate the plurality of polarization modalities including the single field source, the differential field source, and the integral field source successively; each receiving station acquires data; and at this time, an idle charging mode is enabled for other mixed stimulus systems.

S43: other mixed stimulus systems are turned on in sequence to perform observation according to step S42.

S44: next staggered array area is selected and steps S41 to S44 are repeated until the observation is completed for all the staggered array regions. Thus, full-area staggered array observation in the core target area is realized.

During data acquisition, the information acquisition of the basic observation arrays is firstly completed, and then the information acquisition of the staggered observation arrays is completed. For the basic observation arrays, the stimulation and reception of internal signals of the basic observation arrays are completed by performing comprehensive information acquisition on the area to be explored once. The staggered observation arrays carry out stimulation and reception between the basic observation arrays by utilizing the mixed stimulus systems of the basic observation arrays, thereby realizing multi-angle omnibearing stimulation and reception. The receiving stations in the staggered observation arrays and the receiving stations in the basic observation arrays are distributed in a staggered manner, and densified appropriately according to the requirement on the elaborate degree of exploration. Thus, comprehensive reception of electromagnetic exploration information is realized.

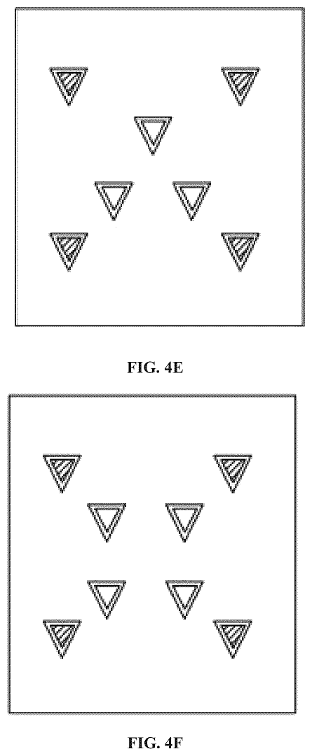

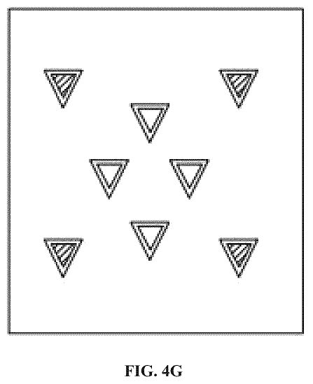

It needs to be noted that the staggered observation array and the basic observation array follow an arrangement principle of the mixed stimulus system being shared and the receiving stations being densified. The receiving stations of the staggered observation array may be densified to different extents according to the requirement on the elaborate degree of exploration in the core target area. FIGS. 4A-4G illustrate, by way of example, distributions of receiving stations in the staggered observation arrays after different numbers of densified nodes are used in the basic observation arrays. As shown in FIGS. 4A-4G, it is assumed that four receiving stations are shown in the basic observation arrays, densification is carried out in one-point, two-point, three-point, and four-point densification manners for the staggered observation arrays, respectively. Specifically, in FIGS. 4A-4G, FIG. 4A is the one-point densification manner; (FIG. 4B) and (FIG. 4C) are two two-point densification manners; (FIG. 4D) and (FIG. 4E) are two three-point densification manners; and (FIG. 4F) and (FIG. 4G) are two four-point densification manners. In specific construction, densified acquisition manners requiring elaborate detection in an area are not limited to FIGS. 4A-4G. The densification manner may be adjusted flexibly according to complex geographic and geomorphic conditions of the exploration area. The densified arrangement manner is flexible and capable of arbitrary coverage. The receiving stations are densified based on the staggered observation arrays, and information stimulation and reception between different arrays can be perfected. Breaking through the boundary of far area observation, the influences of the field source effect and the shadow effect can be avoided; multi-angle, omnidirectional, comprehensive and systematic information reception is realized; and a correct exploration effect can be achieved under complex conditions.

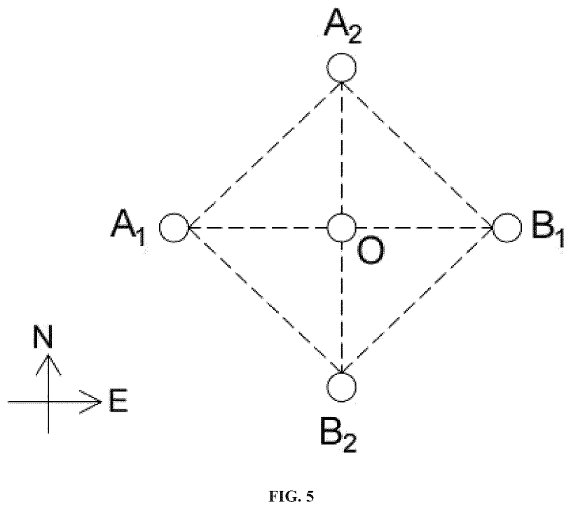

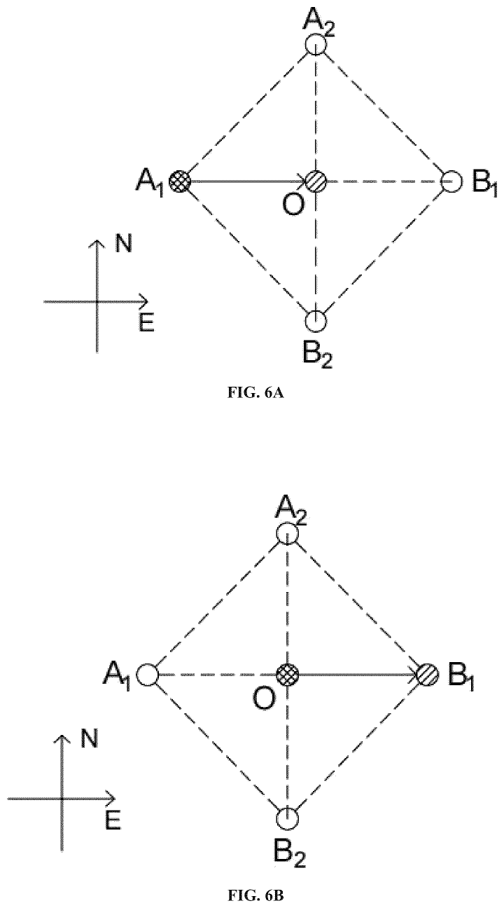

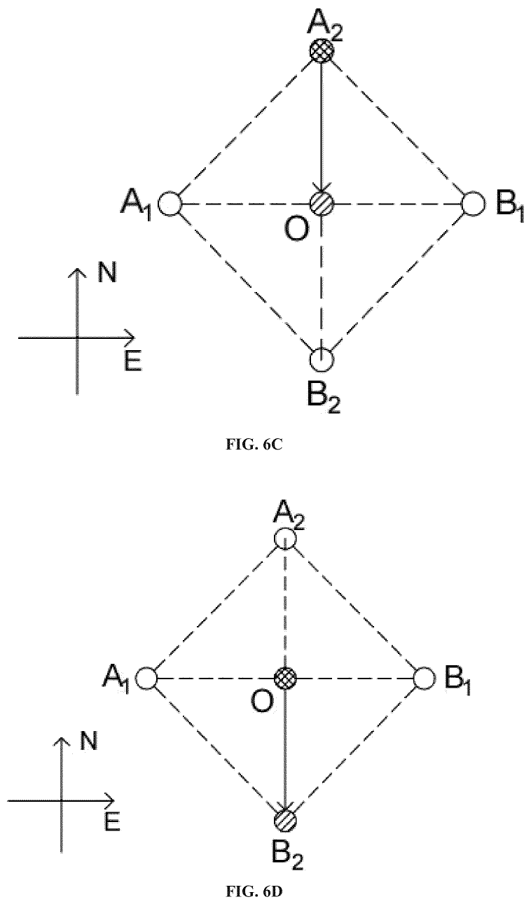

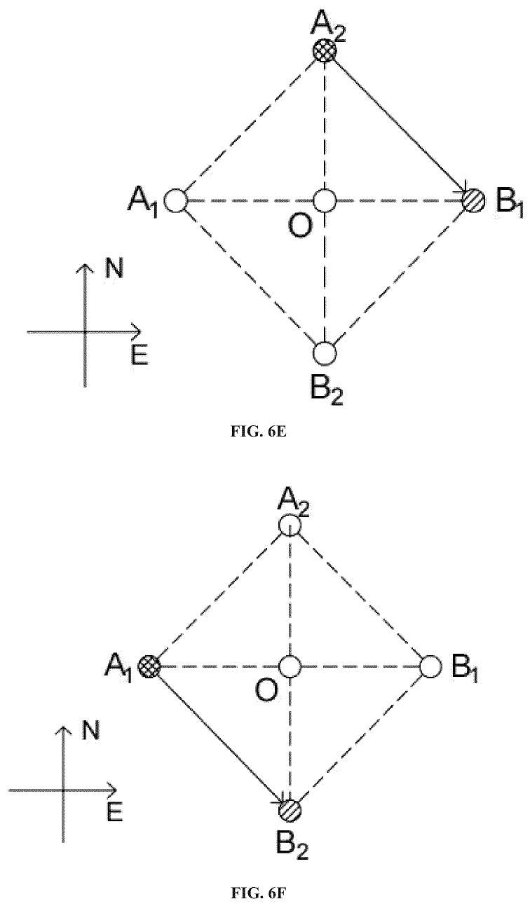

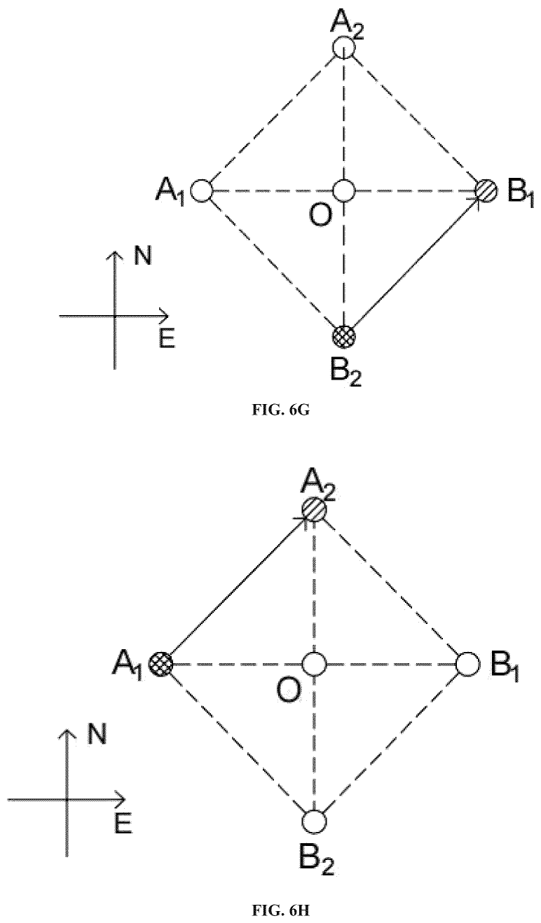

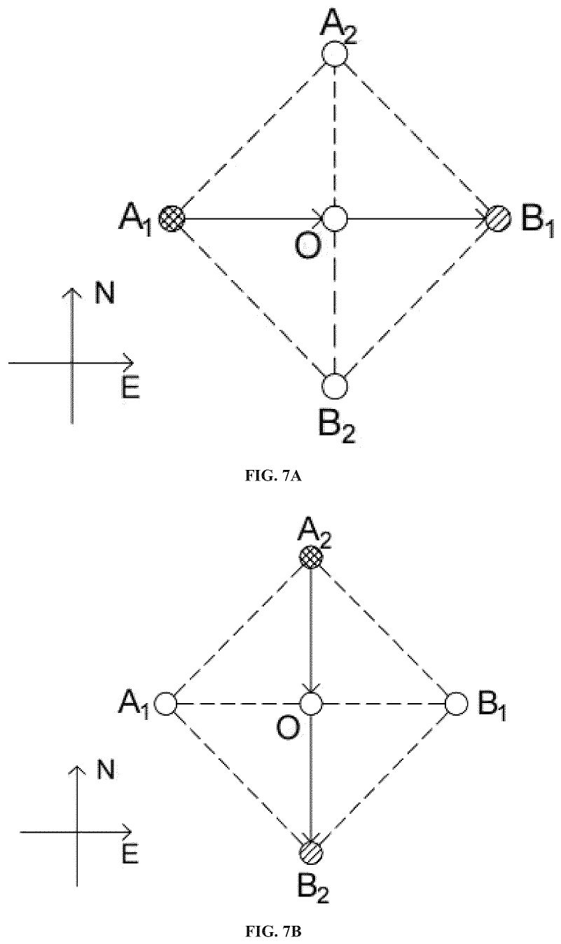

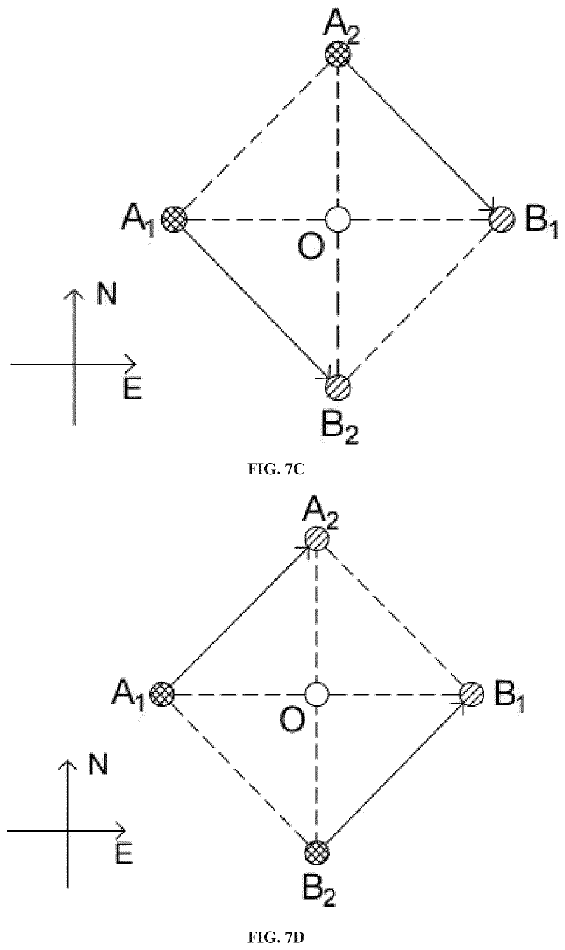

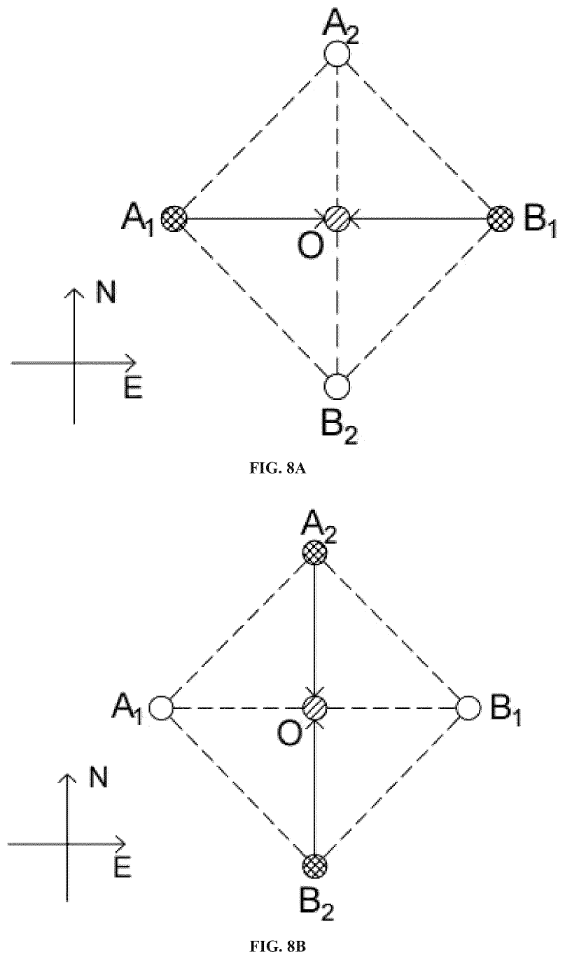

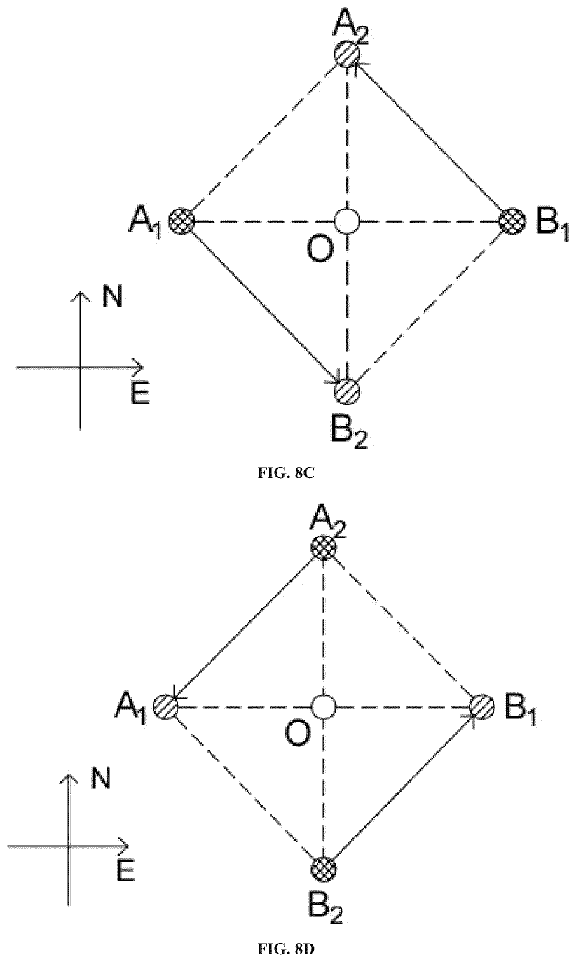

As shown in FIG. 5, in the present embodiment, an electrode system of the mixed stimulus system includes five electrodes (A1, A2, B1, B2, O) arranged centrosymmetrically in a cross form, where the four electrodes A1, A2, B1, and B2 are centrosymmetrical about the center electrode O, and 16 power supply combination modes. 8 power supply modes of a single set of positive and negative electrodes are configured to stimulate the polarization modality of the single field source, as shown in FIG. 6A to FIG. 6H, with the arrow direction indicating the current flow direction. 4 power supply modes of two sets of positive and negative electrodes having a same current flow direction are configured to stimulate the polarization modality of the integral field source, as shown in FIG. 7A to FIG. 7 D, with the arrow direction indicating the current flow direction. 4 power supply modes of two sets of positive and negative electrodes having opposite current flow directions are configured to stimulate the polarization modality of the differential field source, as shown in FIG. 8A to FIG. 8D, with the arrow direction indicating the current flow direction. The single, integral and differential mixed stimulus system provided in the present disclosure physically realizes a plurality of stimulus manners of the single field source, the differential field source, and the integral field source, and can acquire underground three-dimensional target body information in different modes from different angles and different orientations. Correct imaging is facilitated and the resolution is increased.

In the present embodiment, field components receiving stations are divided into the following three cases: (1) two electric field components are received; (2) three magnetic field components are received; and (3) two electric field components and three magnetic field components are received. Unlike some existing gradient field receiving systems, since the source in the present disclosure employs differential emission, and the receiving system still receives the field components by a traditional method.

In the present embodiment, holographic data acquisition and processing have the following characteristics: (1) the emission signals of the mixed stimulus systems are a set of square wave signals of high frequency (1000 Hz) to low frequency (0.1 Hz), and time series of the electric field, the magnetic field, and the gradient are sampled at equal intervals; (2) in an emission interval, the receiving stations acquire natural source electric field and magnetic field signals with high efficiency; (3) natural source signals and artificial source signals can be identified and separated according to emission waveforms, emission current, and time, and the time domain information and frequency domain information of the electric field and the magnetic field, and the resistivity information and the polarizability information of the underground medium can be obtained; and (4) the information of various electric properties is fused to perform synthesized inversion imaging and quantitative interpretation with high resolution; and universal applicability to elaborate exploration under arbitrary complex geological conditions is exhibited. The time domain information and the frequency domain information of the electric field and the magnetic field, and the resistivity information and the polarizability information of the underground medium are obtained according to the acquired electric field and magnetic field information, and holographic synthesized inversion imaging is performed on the acquired data. The specific methods of the data processing are all prior art, which will not be described here redundantly.

Specific implementation steps are as follows:

Step 1, square wave signals of different frequencies are emitted by utilizing the single, integral and differential mixed stimulus system, and the information of the eclectic field and the magnetic field of an artificial source and the gradient field thereof is received.

Step 2, in the emission interval, the receiving stations acquire the information of the electric field and the magnetic field of a natural source and the gradient thereof.

Step 3, all the acquired data are separated into two parts: artificial source signals and natural source signals; and a time domain signal and a frequency domain signal are identified and extracted from the artificial source signals and natural source signals, respectively, to obtain resistivity information and polarizability information of an underground medium.

Step 4, holographic synthesized inversion imaging is performed on the data acquired by full-area observation alternating coverage integral-difference mixed stimulus, and elaborate imaging and quantitative interpretation of the exploration area are realized.

The holographic electromagnetic exploration method based on full-area observation alternating coverage integral-difference mixed stimulus provided in the present disclosure is integrated with multiple functions, multiple information, and multiple components based on differential integral mixed stimulus. The main excellent characteristics are as follows:

(1) Based on full-area observation alternating coverage observation, the electromagnetic field data acquisition is divided into basic array observation and staggered array observation. Firstly, first basic array observation is performed on the whole exploration area, and then staggered array observation is performed on the core target area of exploration. The staggered arrays stimulate reception between the basic arrays by utilizing the emission sources of the basic arrays, thereby realizing multi-angle omnibearing stimulation and reception. The receiving stations in the staggered arrays and the receiving stations in the basic arrays are distributed in a staggered manner, and densified appropriately according to the requirement on the elaborate degree of exploration. Thus, comprehensive reception of electromagnetic field information is realized. Breaking through the boundary of far area observation, the influences of the field source effect and the shadow effect can be avoided, and a correct exploration effect can be achieved under complex conditions. Single component and differential field source are received, and the resolution is increased.

(2) The method physically realizes the plurality of stimulus manners of the single field source, the differential field source, and the integral field source, and can acquire underground three-dimensional target body information in different modes from different angles and different orientations. Correct imaging is facilitated and the resolution is increased.

(3) According to the method, information of “geometric sounding (a change in separation between a receiver and a transmitter)” and “electromagnetic induction (a frequency change)”, information of the single field source, the differential field source, and the integral field source, time domain and frequency domain information, information of an artificial field source and a natural field source, resistivity and polarizability information, and information of three electromagnetic field components and gradients thereof are acquired synchronously by performing field acquisition once. The exploration resolution and the working efficiency are effectively improved. Inversion is performed by utilizing all the electromagnetic field information, and correct, accurate high-resolution imaging on the exploration area is realized.

Although the examples of the present disclosure have been illustrated and described, it should be understood that persons of ordinary skill in the art may make various changes, modifications, replacements and variations to the above examples without departing from the principle and spirit of the present disclosure, and the scope of the present disclosure is limited by the appended claims and their equivalents.

What is claimed is:

1. A holographic electromagnetic exploration method based on full-area observation alternating coverage integral-difference mixed stimulus, comprising:
S1: determining an area to be explored and a core target area of the area to be explored;
S2: dividing the area to be explored into a plurality of basic array areas, dividing the core target area into a plurality of staggered array areas, and determining a plurality of mixed stimulus system arrangement positions within the area to be explored;
S3: arranging a basic observation array composed of receiving stations in each basic array area successively, and adjusting each mixed stimulus system one by one such that the mixed stimulus system stimulates a plurality of polarization modalities comprising a single field source, a differential field source, and an integral field source successively, during which each receiving station acquires data; and
S4; arranging a staggered observation array composed of receiving stations in each staggered array area successively, and adjusting each mixed stimulus system one by one such that the mixed stimulus system stimulates a plurality of polarization modalities comprising a single field source, a differential field source, and an integral field source successively, during which each receiving station acquires data.

2. The holographic electromagnetic exploration method based on full-area observation alternating coverage integral-difference mixed stimulus according to claim 1, wherein an electrode system of the mixed stimulus system comprises five electrodes arranged centrosymmetrically in a cross form, involving 16 power supply combination modes, wherein 8 power supply modes of a single set of positive and negative electrodes are configured to stimulate the polarization modality of the single field source; 4 power supply modes of two sets of positive and negative electrodes having a same current flow direction are configured to stimulate the polarization modality of the integral field source; and 4 power supply modes of two sets of positive and negative electrodes having opposite current flow directions are configured to stimulate the polarization modality of the differential field source.

3. The holographic electromagnetic exploration method based on full-area observation alternating coverage integral-difference mixed stimulus according to claim 1, wherein the staggered observation array and the basic observation array follow an arrangement principle of the mixed stimulus system being shared and the receiving stations being densified.

4. The holographic electromagnetic exploration method based on full-area observation alternating coverage integral-difference mixed stimulus according to claim 1, wherein the adjusting each mixed stimulus system one by one such that the mixed stimulus system stimulates a plurality of polarization modalities comprising a single field source, a differential field source, and an integral field source successively, during which each receiving station acquires data, specifically comprises the following steps:
A1: turning on a mixed stimulus system to stimulate the plurality of polarization modalities comprising the single field source, the differential field source, and the integral field source successively, and acquiring data by each receiving station, and at this time, enabling an idle charging mode for other mixed stimulus systems; and
A2: turning on other mixed stimulus systems in sequence to perform observation according to step A1.

5. The holographic electromagnetic exploration method based on full-area observation alternating coverage integral-difference mixed stimulus according to claim 1, wherein an emission signal of the mixed stimulus system is a square wave signal of 1000 Hz to a low frequency of 0.1 Hz.

6. The holographic electromagnetic exploration method based on full-area observation alternating coverage integral-difference mixed stimulus according to claim 1, wherein during emission of the mixed stimulus system, each receiving station acquires an artificial source electric field and/or magnetic field signal; and in an emission interval of the mixed stimulus system, each receiving station acquires a natural source electric field and/or magnetic field signal.

7. The holographic electromagnetic exploration method based on full-area observation alternating coverage integral-difference mixed stimulus according to claim 6, further comprising:
separating all the acquired data into two parts: artificial source signals and natural source signals;
identifying and extracting a time domain signal and a frequency domain signal from the artificial source signals and natural source signals, respectively, to obtain resistivity information and polarizability information of an underground medium; and performing holographic synthesized inversion imaging on all the acquired data.
